(19) United States
(12) Patent Application Publication
(10) Pub. No.: US 2008/0159454 A1
(43) Pub. Date: Jul. 3, 2008

(54) Network on chip device and on-chip data transmission device

(75) Inventors: Jhao-Ji Ye, Taipei City (TW); You-Gang Chen, Taipei City (TW); An-Yeu Wu, Taipei City (TW)

Correspondence Address: Joe McKinney Muncy, PO Box 1364, Fairfax, VA, 22038-1364, US

(73) Assignee: National Taiwan University

(21) Appl. No.: 11/645,722

(22) Filed: Dec. 27, 2006

(51) Int. Cl. H04L 7/00

(52) U.S. Cl. 375/354

(57) ABSTRACT

An on-chip data transmission device. The on-chip data transmission device comprises a transmitter and a receiver. The transmitter transmits a control signal and a packet when a logic level of the control signal changes, wherein the logic level of the control signal changes every clock cycle, and the clock cycle is determined by an input signal clock A. The receiver receives the transmitted control signal and a clock B having a clock rate as same as clock A, generates a mixed clock having a phase substantially the same as the phase of the clock B, and receives one transmitted packet per clock B cycle.

### BACKGROUND OF THE INVENTION

### Field of the Invention

The invention relates to network on chips (NoC), and, more particularly, to transmitting/receiving data asynchronously.

System-on-Chip (SoC) design is a growing trend. In SoC design, on-chip-communication (OCC) is important because it limits throughput rate of the entire chip. Conventional OCC architectures utilize shared bus architecture, referred to as on-chip-bus (OCB), such as the IBM CoreConnect Bus Architecture and the ARM AMBA bus system. FIG. 1 shows a typical OCC architecture. The conventional OCC architecture suffers because all the silicon intellectual property (SIP) blocks are driven by one clock source. The global clock source limits chip performance and each the throughput of each SIP block is hindered by the clock skew.

Multi-clocking is a recent SoC design trend. Multi-clocking is challenged in transmitting data reliably between multiple clock domains. Synchronous multi-clock transmission methods typically suffer from data loss.

### BRIEF SUMMARY OF THE INVENTION

Accordingly, globally asynchronous locally synchronous (GALS) techniques are provided. GALS can achieve data transfer between different clock phases and different clock rates.

An on-chip data transmission device is provided. The on-chip data transmission device comprises a transmitter and a receiver. The transmitter transmits a control signal and a plurality of packets when logic levels of the control signal change. The logic level of the control signal changes every clock cycle. An input signal clock A determines the clock cycle. The receiver receives the transmitted control signal and a clock B signal A generates a first mixed clock having a phase substantially the same as the clock B, is subsequently generated and receives one transmitted packet per clock B cycle.

In another aspect of the invention, a network on chip device is provided. The network on chip device comprises a first silicon intellectual property (SIP) module, a transmitter (TX), a second SIP module, and a receiver RX. The first SIP sets a TX enable signal, generates a clock A signal and the plurality of packets. The transmitter transmits a control signal and the plurality of packets when logic levels of the control signal change, wherein the logic level of the control signal changes every clock cycle, and the clock cycle is determined by the clock A. The second SIP module sets an RX enable signal, and generates a clock B signal. The receiver receives the transmitted control signal and the clock B, and receives one of a plurality of transmitted packets per clock B cycle when the RX enable signal is set.

In another aspect of the invention, a network on chip device comprising a plurality of SIP modules is provided. Each SIP comprises a core module, a transmitter and a receiver. The core module sets a TX enable signal, and generates a clock A signal and a plurality of first packets. The transmitter generates a first control signal when the TX enable signal is set, and transmits the plurality of first packets when a logic level of the first control signal changes. The core module further sets an RX enable signal. The receiver receives a second control signal and receives one of the second packets per clock A cycle.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 shows a general OCC architecture; and

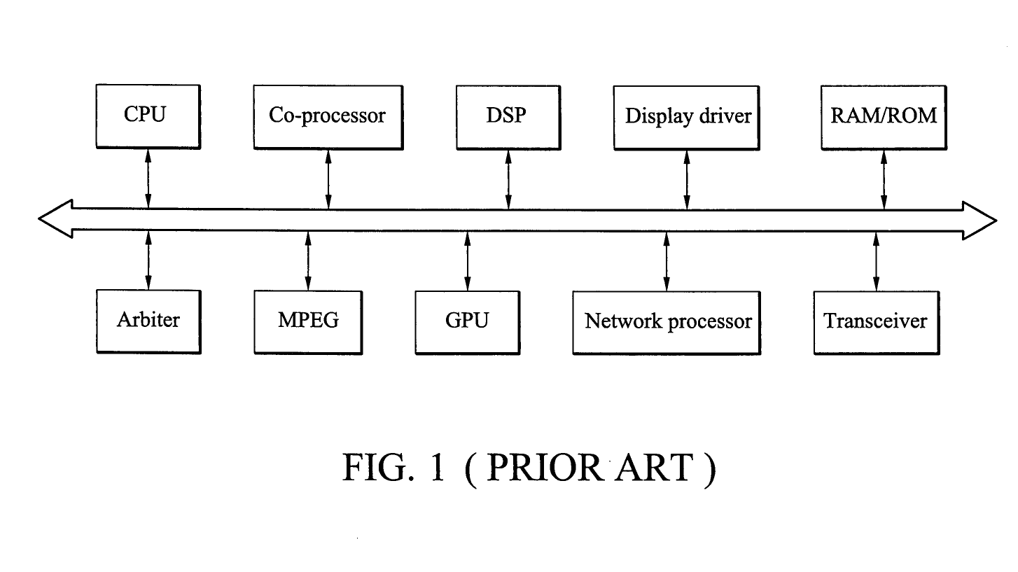

FIG. 2 shows a block diagram of an on-chip data transmission device according to an embodiment of the invention;

FIG. 3 shows a time diagram of the XOR output and the clock B;

FIG. 4 shows an exemplary diagram of the phase adjusting unit according to an embodiment of the invention;

FIG. 5 shows a block diagram of a network chip device according to an embodiment of the invention;

FIG. 6 shows a block diagram of an exemplary network on chip device;

FIG. 7 shows a timing chart of a transmitter of the invention; and

FIG. 8 shows a block diagram of a mutual exclusion unit according to an embodiment of the invention.

### DETAILED DESCRIPTION OF THE INVENTION

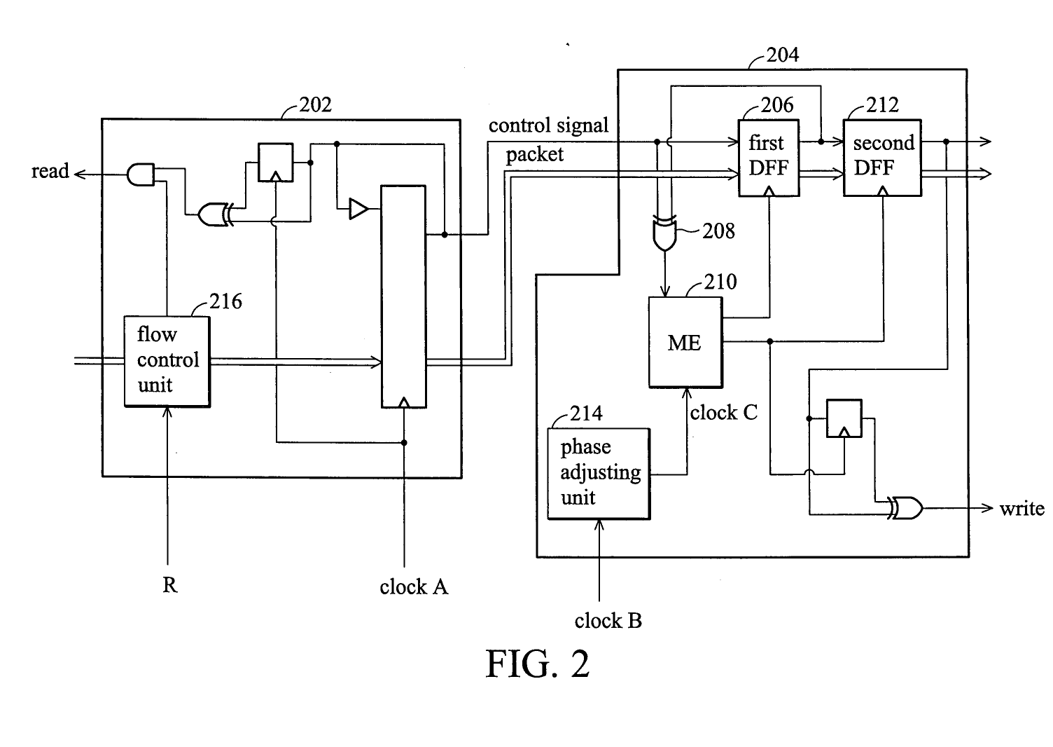

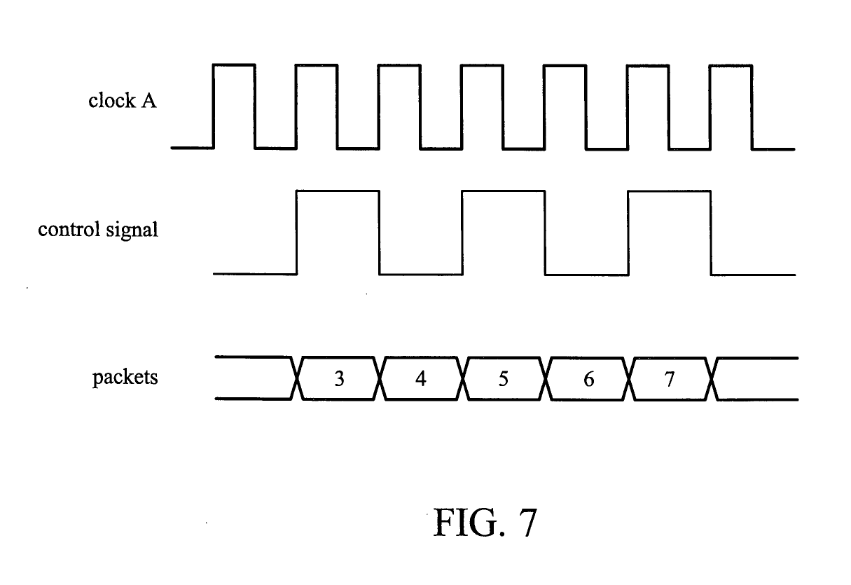

FIG. 2 shows a block diagram of an on-chip data transmission device according to an embodiment of the invention. The on-chip data transmission device comprises a transmitter 202 and a receiver 204. The transmitter 202 transmits a control signal and a plurality of packets when a logic level of the control signal changes, wherein the logic level of the control signal changes every clock cycle, and the clock cycle is determined by an input signal clock A. FIG. 7 shows a timing chart of the transmitter of this embodiment. The receiver 204 receives the transmitted control signal and a clock B signal, generates a first mixed clock having a phase substantially the same as the phase of the clock B, and receives one transmitted packet per clock B cycle. The receiver 204 also generates a write signal to indicate that the receiver 204 is receiving transmitted packets.

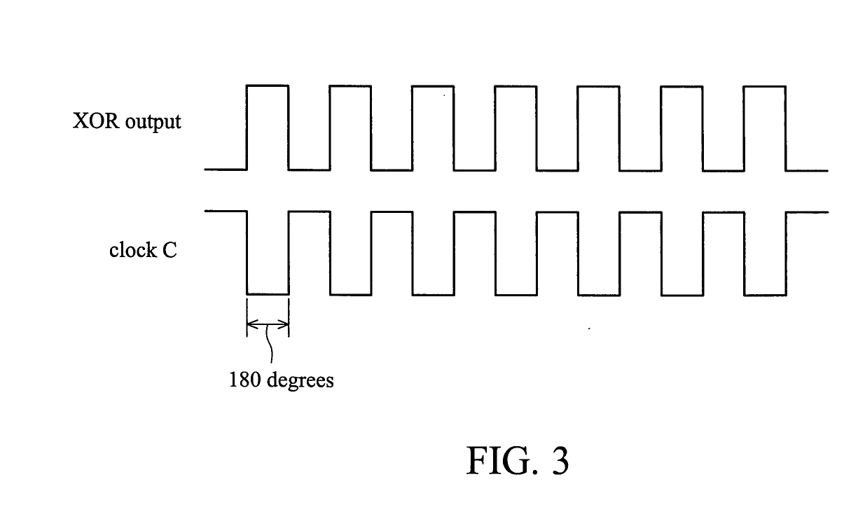

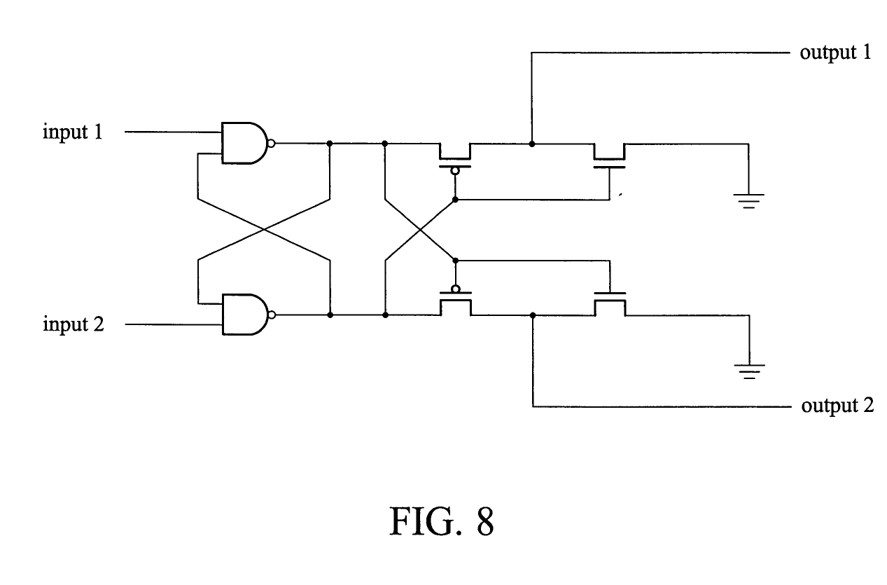

In one embodiment of the invention, the receiver 204 comprises a first D flip-flop (DFF) 206, an exclusive-or (XOR) gate 208, a mutual exclusion unit (ME) 210, and a second DFF 212. The first DFF 206 has a control input, a data input bus, a clock input, a control output bus and a data output bus. The first DFF 206 accepts the transmitted control signal as the control input, the first mixed clock as clock input, the transmitted packets as the data input bus, and generates a first DFF control output and a first DFF data output bus. The exclusive-or (XOR) gate 208 generates an XOR output according to the transmitted control signal and the first DFF control output. The mutual exclusion unit (ME) 210 accepts the XOR output and a clock C to generate the first mixed clock and a second mixed clock. The mutual exclusion unit 210, is implemented as shown in FIG. 8. FIG. 8, however, is not limitative of the invention. The clock C lags the XOR output half cycle, shown as FIG. 3. The first mixed clock has a phase substantially the same as the phase of the XOR output, and the second mixed clock has a phase substantially the same as the phase of the clock B. The second DFF 212 also has a control input, a data input bus, a clock input, a control output and a data output bus. The second DFF 212 accepts the first DFF control output as the control input, the second mixed clock as the clock input, the first DFF data output as the data input bus, and generates a second DFF control output and a second DFF data output.

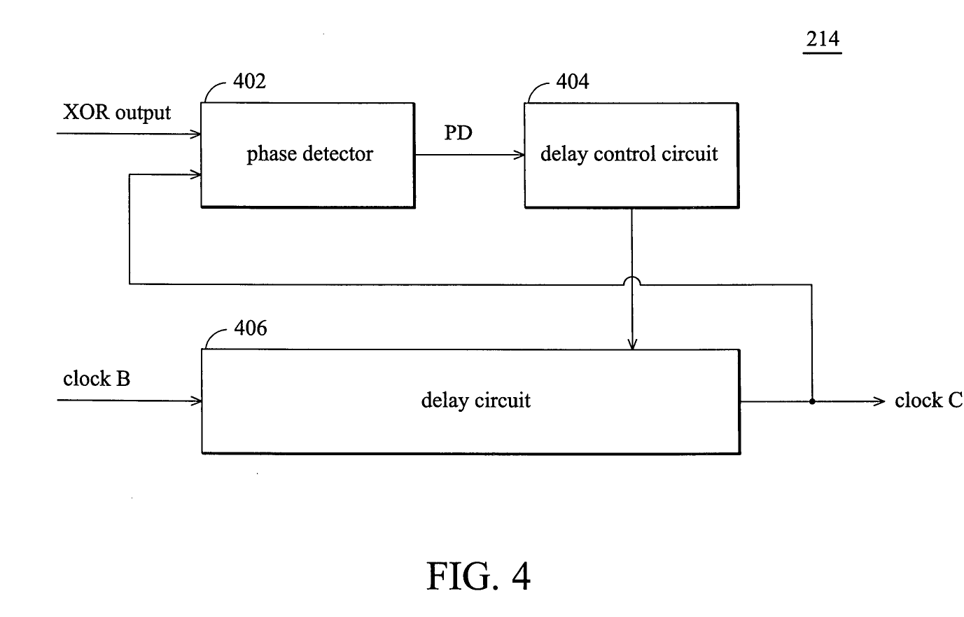

In some embodiments, the receiver 204 further comprises a phase adjusting unit 214 to assure that the phase of the clock C lags the XOR output by 180 degrees. FIG. 4 is a diagram of phase adjusting unit 214 of an embodiment of the invention. The phase adjusting unit 214 comprises a phase detector 402, a delay control circuit 404, and a delay circuit 406. The phase detector 402 detects a phase difference of the XOR output and the clock B, and activating a PD signal when the phase difference of the XOR output and the clock B exists. The delay control circuit 404 sends a delay control signal to the delay circuit 406. The delay circuit 406 delays the clock B in response to the delay control single to generate the clock C, which keeps the phase of the clock C 180 degrees behind the XOR output. The rate of the clock A over the clock B may be characterized in 3 ways:
clock B has substantially the same rate as clock A;
clock B is faster than clock A; and
clock B is slower than the clock A.

Since the receiver 204 receives one packet per clock B cycle, when clock B is slower than clock A, receiver 204 may miss some packets. Thus, in some embodiments of the invention, the transmitter 202 further comprises a flow control unit 202 to control a packet transmission rate. The flow control unit 216 receives signal R indicating the ratio of the clock rate A over clock rate B. When clock B is slower than clock A, the packet transmission rate is kept substantially the same as one packet per clock B cycle. The flow control unit 216 further activates a read signal to indicate that the transmitter 202 is transmitting packets.

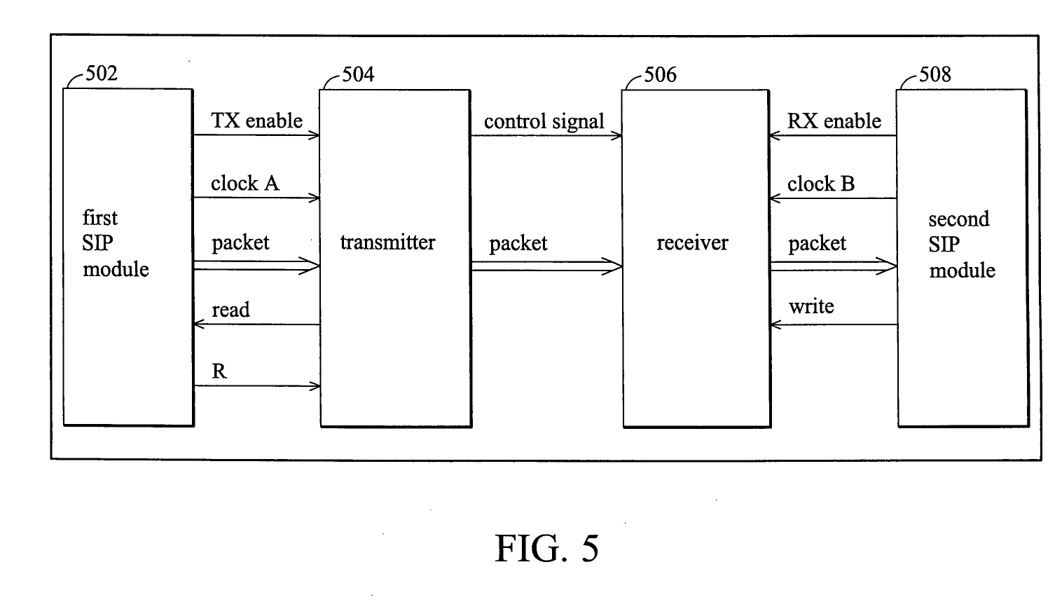

In another aspect of the invention, a network on chip device is provided. FIG. 5 shows a block diagram of a network chip device according to the embodiment of the invention. The network on chip device comprises a first silicon intellectual property (SIP) module 502, a transmitter (TX) 504, a second SIP module 506, and a receiver RX 508. The first SIP module 502 sets a TX enable signal, generates a clock A signal and a plurality of packets. The transmitter 504, connecting to the first SIP module 502, generates a control signal when the TX enable signal is set, and transmits the plurality of packets when the logic level of the control signal changes. The transmitter 504 is substantially the same as shown in FIG. 2, thus, a detailed description of transmitter 504 is omitted. The second SIP module 506 sets an RX enable signal, and generating a clock B signal. The receiver 506 receives the transmitted control signal and the clock B, and receives one of a plurality of transmitted packets per clock B cycle when the RX enable signal is set. The receiver 506 in this embodiment may be the same as the receiver shown in FIG. 2.

In some embodiments, the transmitter 506 further receives an R signal indicating the ratio of clock rate A over the clock rate B. When the rate of clock B is slower than the rate of clock A, a packet transmission rate is kept substantially at one packet per clock B cycle. The transmitter 504 further activates a read signal to indicate to the first SIP module 502 that the transmitter 504 is transmitting the plurality of packets.

Similarly, the receiver 506 may further generate a write signal to indicate to the second SIP module 508 that the receiver 506 is receiving the plurality of transmitted packets.

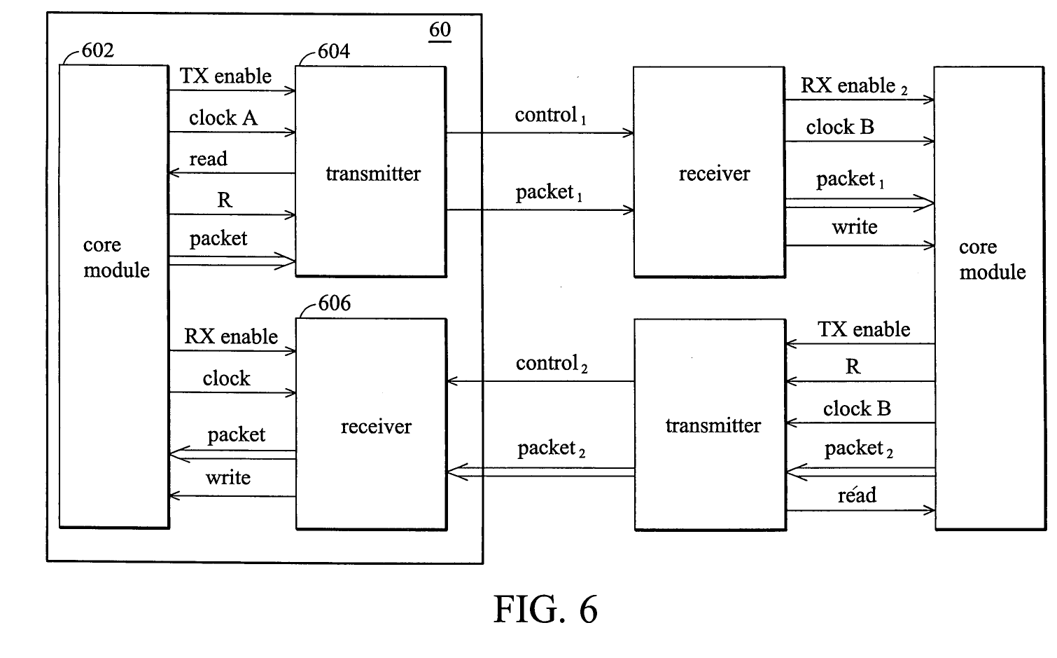

In another aspect of the invention, a network on chip device comprising a plurality of SIP modules is provided. FIG. 6 is a block diagram of an exemplary network on chip device. Each SIP 60 comprises a core module 602, a transmitter 604 and a receiver 606. The core module 602 sets a TX enable signal, and generates a clock A signal and a plurality of first packets. The transmitter 604 generates a first control signal when the TX enable signal is set, and transmits the plurality of first packets when a logic level of the control signal changes. The core module 602 further sets an RX enable signal. The receiver 606 receives a second control signal and one of a plurality of second packets per clock A cycle.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A network on chip device, comprising:
a first silicon intellectual property (SIP) module generating a plurality of packets, setting a TX enable signal, and generating a clock A signal;
a transmitter coupling to the first SIP module, generating a control signal when the TX enable signal is set, and transmitting the plurality of packets when a logic level of the control signal changes, wherein the logic level of the control signal changes every clock cycle, and the clock cycle is determined by the clock A signal;
a second SIP module receiving the transmitted packet, setting an RX enable signal, and generating a clock B signal; and
a receiver receiving the transmitted control signal and the clock B, generating a first mixed clock having a phase substantially the same as the phase of the clock B, and receiving one of a plurality of transmitted packets per clock B cycle.

2. The network on chip device as claimed in claim 1, wherein the transmitter further comprises a flow control unit to control a packet transmission rate, and when the clock B is slower than clock A, the packet transmission rate is kept substantially at one packet per clock B cycle.

3. The network on chip device as claimed in claim 2, wherein the flow control unit further activates a read signal to indicate to the first SIP module that the transmitter is transmitting the plurality of packets.

4. The network on chip device as claimed in claim 1, wherein the receiver further generates a write signal to indicate to the second SIP that the receiver is receiving the plurality of transmitted packets.

5. The network on chip device as claimed in claim 1, wherein the receiver further comprises:
a first D flip-flop (DFF), having a control input, a data input bus, a clock input, a control output and a data output bus, accepting the transmitted control signal as the control input, the first mixed clock as clock input, the transmitted packets as the data input bus and generating a first DFF control output and a first DFF data output;
an exclusive-or (XOR) gate generating an XOR output according to the transmitted control signal and the first DFF control output;
a mutual exclusion unit accepting the XOR output and a clock C to generate the first mixed clock and a second mixed clock, wherein a phase of the clock C lags a phase of XOR output 180 degrees, the first mixed clock has a phase substantially the same as the phase of the XOR output, and the second mixed clock has a phase substantially the same as the phase of the clock C; and
a second D flip-flop, having a control input, a data input bus, a clock input, a control output and a data output bus, accepting the first DFF control output signal as the control input, the second mixed clock as the clock input, accepting the first DFF data output as the data input bus, generating a second DFF control output and a DFF second data output.

6. The network on chip device e as claimed in claim 5, wherein the receiver further comprises a phase adjusting unit comprising:
a phase detector detecting a phase difference of the XOR output and the clock B, and activating a PD signal when the phase difference of the XOR output and the clock B exists;
a delay control circuit sending a delay control signal; and
a delay circuit delaying the clock B in response of the delay control single to generate the clock C, wherein the phase of the clock B lags the XOR output by 180 degrees.

7. An on-chip data transmission device, comprising:
a transmitter transmitting a control signal and a plurality of packets when a logic level of the control signal changes, wherein the logic level of the control signal changes every clock A cycle, and the clock A cycle is determined by an input signal clock A;
a receiver receiving the transmitted control signal and a clock B, generating a mixed clock having a phase substantially the same as the phase of the clock B, and receiving one transmitted packet per clock B cycle.

8. The on-chip data transmission device as claimed in claim 7, wherein the transmitter further comprises a flow control unit to control a packet transmission rate, and when the clock B is slower than clock A, the packet transmission rate is kept substantially at one packet per clock B cycle.

9. The on-chip data transmission device as claimed in claim 8, wherein the flow control unit further activates a read signal to indicate that the transmitter is transmitting the plurality of packets.

10. The on-chip data transmission device as claimed in claim 7, wherein the receiver further generates a write signal to indicate that the receiver is receiving the plurality of transmitted packets.

11. The on-chip data transmission device as claimed in claim 7, when the transmitted control signal starts to change logic levels, the receiver starts to receive the transmitted packet, and the receiver further comprises:
a first D flip-flop (DFF), having a control input, a data input bus, a clock input, a control output and a data output bus, accepting the transmitted control signal as the control input, a first mixed clock as clock input, the plurality of transmitted packet as the data input bus and generating a first DFF control output and a first DFF data output;
an exclusive-or (XOR) gate generating an XOR output according to the transmitted control signal and the first DFF control output;
a mutual exclusion unit accepting the XOR output and a clock C to generate the first mixed clock and a second mixed clock, wherein a phase of the clock C lags the phase of the XOR output 180 degrees, the first mixed clock has a phase substantially the same as the phase of the XOR output, and the second mixed clock has a phase substantially the same as the phase of the clock C, wherein the mixed clock equals to the second mixed clock; and
a second D flip-flop, also having a control input, a data input bus, a clock input, a control output and a data output bus, accepting the first DFF control output as the control input, the second mixed clock as the clock input, the first DFF data output as the data input bus, and generating a second DFF control output and a DFF second data output.

12. The on-chip data transmission device as claimed in claim 11, wherein the receiver further comprises a phase adjusting unit comprising:
a phase detector detecting a phase difference of the XOR output and the clock B, and activating a PD signal when the phase difference of the XOR output and the clock B exists;
a delay control circuit sending a delay control signal; and
a delay circuit delaying the clock C in response of the delay control single to generate the clock B, keeping the phase of the clock B lagging the XOR output by 180 degrees.

13. A network on chip device, comprising:
a silicon intellectual property (SIP) module generating a plurality of packets, comprising:
a core module setting a TX enable signal and setting an RX enable signal, and generating a clock A signal and a plurality of first packets;
a transmitter generating a first control signal when the TX enable signal is set, and transmitting the plurality of first packets when a logic level of the control signal changes, wherein the logic level of the control signal changes every clock cycle, and the clock cycle is determined by the clock A signal; and
a receiver receiving a second control signal and a plurality of second packets, generating a mixed clock having a phase substantially the same as the phase of the clock A, and receiving one of a plurality of second packets per clock A cycle when the RX enable signal is set.

14. The network on chip device as claimed in claim 13, wherein the receiver further comprises:
a first D flip-flop (DFF), having a control input, a data input bus, a clock input, a control output and a data output bus, accepting the transmitted control signal as the control input, a first mixed clock as clock input, accepting the plurality of second packet as the data input and generating a first DFF control output and a first DFF data output;
an exclusive-or (XOR) gate generating an XOR output according to the transmitted control signal and the first DFF control output;
a mutual exclusion unit accepting the XOR output and a clock C to generate the first mixed clock and a second mixed clock, wherein the phase of the clock C lags the XOR output by 180 degrees, the first mixed clock has a phase substantially the same as the phase of the XOR output, and the second mixed clock has a phase substantially the same as the phase of the clock B, wherein the mixed clock is equivalent to the second mixed clock; and
a second D flip-flop, having a control input, a data input bus, a clock input, a control output and a data output bus, accepting the first DFF control output as the control input, the first DFF control output as input, the second mixed clock as the clock input, accepting the first DFF data output as the data input, generating a second DFF control output and a second DFF data output.

15. The network on chip device as claimed in claim 14, wherein the receiver further comprises a phase adjusting unit comprising:
a phase detector detecting a phase difference of the XOR output and the clock A, and activating a PD signal when the phase difference of the XOR output and the clock A exists;
a delay control circuit sending a delay control signal; and
a delay circuit delaying the clock A in response of the delay control single to generate the clock C, wherein the phase of the clock C lags the XOR output by 180 degrees.
